(19) United States
(12) Patent Application Publication
(10) Pub. No.: US 2017/0074026 A1
(43) Pub. Date: Mar. 16, 2017

(54) WOOD FRAME USING WATER SOLUBLE ADHESIVE AND MANUFACTURING METHOD THEREOF

(71) Applicant: KUKJE MACHINERY & METAL Co., Ltd., Nonsan-si (KR)

(72) Inventor: Kyong-Bai LEE, Daejeon (KR)

(73) Assignee: KUKJE MACHINERY & METAL Co., ltd., Nonsan-si (KR)

(21) Appl. No.: 15/259,178

(22) Filed: Sep. 8, 2016

(30) Foreign Application Priority Data
Sep. 11, 2015 (KR) 10-2015-0128787

(51) Int. Cl. E06B 3/12; E06B 3/10; E04F 11/18; C09J 123/02

(52) U.S. Cl. CPC E06B 3/12; C09J 123/02; E06B 3/10; E04F 11/18; E04F 2011/1889

(57) ABSTRACT

Disclosed is a wood frame using a water soluble adhesive and a manufacturing method thereof. The wood frame is manufactured by coating a metal frame with a wood-plastic composite after application of the water soluble adhesive to the metal frame, and may thus have internal rigidity of metal and excellent external flexibility, elasticity, water resistance and corrosion resistance, have an eco-friendly texture like natural wood and prevent deformation due to thermal expansion.

### BACKGROUND OF THE INVENTION

Field of the Invention

The present invention relates to a wood frame using a water soluble adhesive and a manufacturing method thereof and, more particularly, to a wood frame using a water soluble adhesive, which is manufactured by coating a metal frame with a wood-plastic composite after application of the water soluble adhesive to the metal frame, and may thus have internal rigidity of metal and excellent external flexibility, elasticity, water resistance and corrosion resistance, have an eco-friendly texture like natural wood and prevent deformation due to thermal expansion, and a manufacturing method thereof.

Description of the Related Art

In general, wood frames manufactured from various plywoods, such as hardwood, a medium density fiberboard (MDF), a particle board (PB), hard a board, etc., are cut into pieces having designated lengths and widths and then used for various purposes in window frames, door frames, handrails, Korean-style houses, etc. so as to create an eco-friendly feeling.

However, frames formed of only wood have small load and strength and may thus be used only for limited purposes.

In order to solve such a problem, Korean Patent Registration No. 10-1242016 titled “Wood frame for Korean-style houses” has been proposed.

Such a conventional wood frame is configured such that a cover is combined with outer sides of an H-frame and an acceptor made of steel through a wood coupling member using a screw.

Therefore, the wood coupling member is combined with the outer side of the accepter, in which the frame is received, using the screw fastened to the inside of the accepter.

In such a conventional wood frame, the accepter and the wood coupling member are formed integrally through screw-combination but one surface of the accepter should be opened so as to achieve screw-combination, costs are increased due to a process for screw-combination, and the opened surface of the accepter for screw-combination has a configuration, with which the wood coupling member is difficult combine.

Further, when a screw head protrudes during screw-combination, many restrictions occur according to usages and thus, the screw should be processed such that the screw head may be inserted.

Further, the conventional wood frame consists of the accepter and the wood coupling member having different coefficients of thermal expansion and may thus warp and broken due to thermal expansion and contraction according to temperature variation.

### SUMMARY OF THE INVENTION

Therefore, the present invention has been made in view of the above problems, and it is an object of the present invention to provide a wood frame using a water soluble adhesive, in which a metal frame is coated with a wood-plastic composite after application of the water soluble adhesive to the metal and thus the manufactured wood frame has internal rigidity of metal and an exterior wood texture, and a manufacturing method thereof.

It is another object of the present invention to provide a wood frame using a water soluble adhesive, in which a metal frame and a wood-plastic composite are uniformly attached to each other using the water soluble adhesive so as to absorb impact and to prevent warpage, damage, etc. of the metal frame and the wood-plastic composite having different coefficients of thermal expansion due to expansion and contraction, and a manufacturing method thereof.

In accordance with an aspect of the present invention, the above and other objects can be accomplished by the provision of a wood frame using a water soluble adhesive to prevent deformation due to different coefficients of thermal expansion between materials, the wood frame including a metal frame including reinforcement ribs provided therein to increase strength, the water soluble adhesive applied to the metal frame, and a wood-plastic composite in a liquid state coated on the metal frame provided with the water soluble adhesive applied thereto, wherein the water soluble adhesive is manufactured by mixing 19-20% by weight of modified polyolefin, 59-62% by weight of water, 0.01-5% by weight of isopropyl alcohol and 15-18% by weight of acrylic acid rubber latex, and the wood-plastic composite is manufactured by mixing 47-60% by weight of wood flour, 30-43% by weight of a plastic compound and 5-10% by weight of additives.

Guide parts selectively including protrusions and recesses to prevent deformation of the metal frame provided with the water soluble adhesive applied thereto and the wood-plastic composite coated thereon due to thermal expansion may be formed on the metal frame.

Cutting parts may be formed on the metal frame in the lateral direction so as to divide deformation of the metal frame due to thermal expansion.

5-10% by volume of iron rods including a magnetic substance or fibers coated with a magnetic substance may be added to 100% by volume of the water soluble adhesive, and, after the water soluble adhesive containing the iron rods of the fibers is applied to the metal frame, the metal frame may be inserted into a coil to generate current so that the iron rods or the fibers are aligned in the length direction.

In accordance with another aspect of the present invention, there is provided a manufacturing method of a wood frame using a water soluble adhesive, including manufacturing a water soluble adhesive by mixing 19-20% by weight of modified polyolefin, 59-62% by weight of water, 0.01-5% by weight of isopropyl alcohol and 15-18% by weight of acrylic acid rubber latex, manufacturing a wood-plastic composite in a liquid state by mixing 47-60% by weight of wood flour, 30-43% by weight of a plastic compound and 5-10% by weight of additives, applying the manufactured water soluble adhesive to a metal frame, coating the manufactured wood-plastic composite in the liquid state on the metal frame provided with the water soluble adhesive applied thereto, and naturally drying the metal frame coated with the wood-plastic composite so that the wood-plastic composite and the water soluble adhesive are solidified.

The manufacturing method may further include adding 5-10% by volume of iron rods or fibers having magnetic properties to 100% by volume of the manufactured water soluble adhesive, after manufacturing of the water soluble adhesive, and aligning the iron rods or the fibers, added to the water soluble adhesive applied to the metal frame, in the length direction by inserting the metal frame into a coil generating current, after application of the manufactured water soluble adhesive to the metal frame.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a wood frame using a water soluble adhesive in accordance with the present invention;

FIGS. 2A and 2B are conceptual views illustrating a bonding order of the wood frame in accordance with the present invention;

FIGS. 3A to 3C are cross-sectional views illustrating guide parts formed on a metal frame in accordance with the present invention;

FIG. 4 is a cross-sectional view illustrating cutting parts formed in the metal frame in accordance with the present invention;

FIGS. 5A and 5B are cross-sectional views illustrating water soluble adhesives containing iron rods and fibers in accordance with the present invention;

FIGS. 6A and 6B are perspective views illustrating the alignment state of the iron rods and the fibers added to the water soluble adhesives in accordance with the present invention;

FIG. 7 is a flowchart illustrating a manufacturing method of a wood frame using a water soluble adhesive in accordance with the present invention; and

FIG. 8 is a flowchart illustrating a manufacturing method of a wood frame containing iron rods or fibers in accordance with the present invention.

### DETAILED DESCRIPTION OF THE INVENTION

Reference will now be made in detail to the preferred embodiments of the present invention, examples of which are illustrated in the accompanying drawings.

Hereinafter, a wood frame using a water soluble adhesive and a manufacturing method thereof in accordance with the present invention will be described in detail with reference to the accompanying drawings.

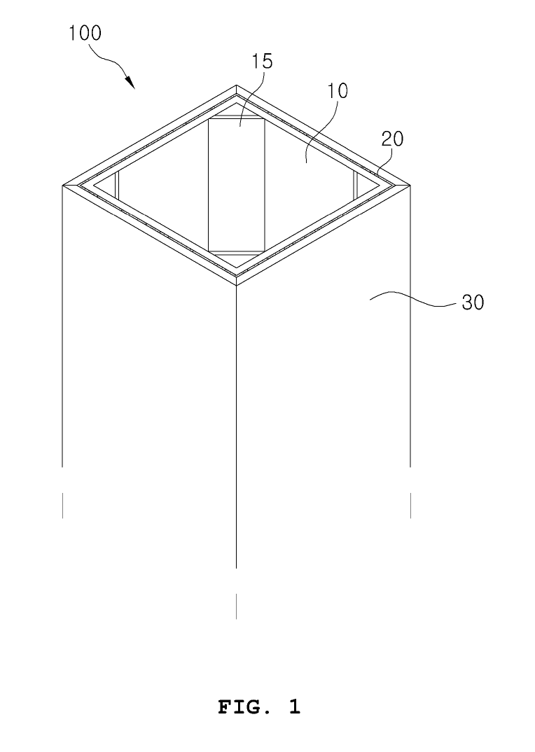

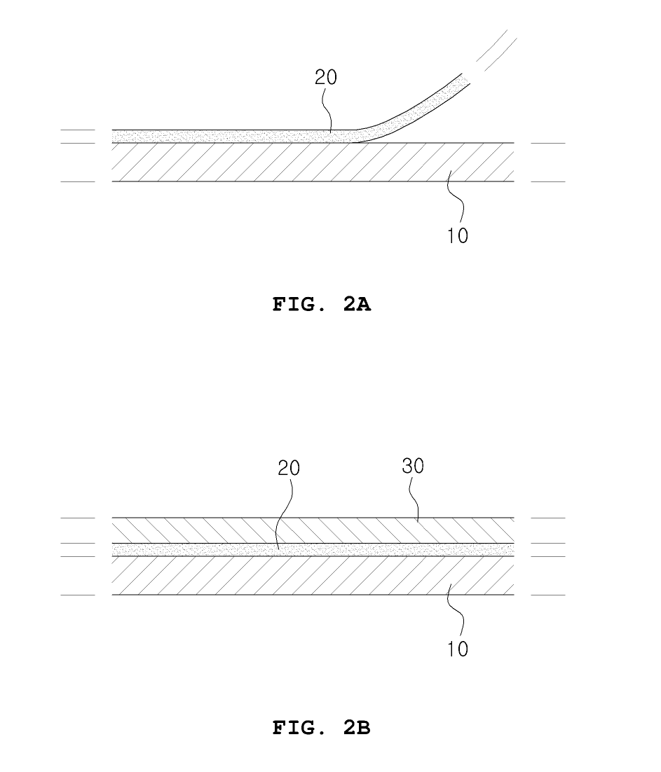

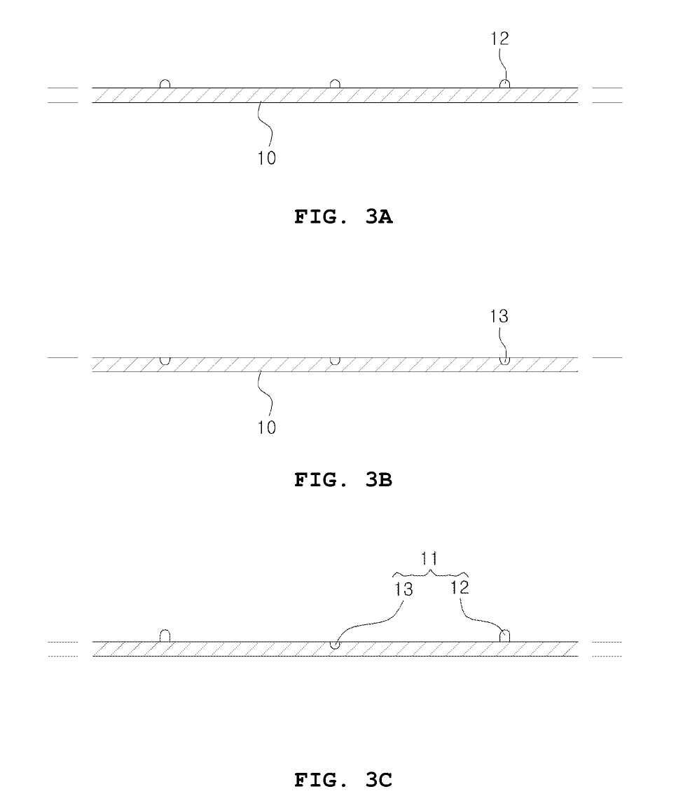

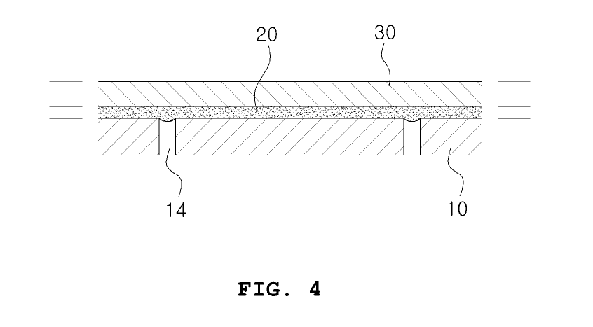

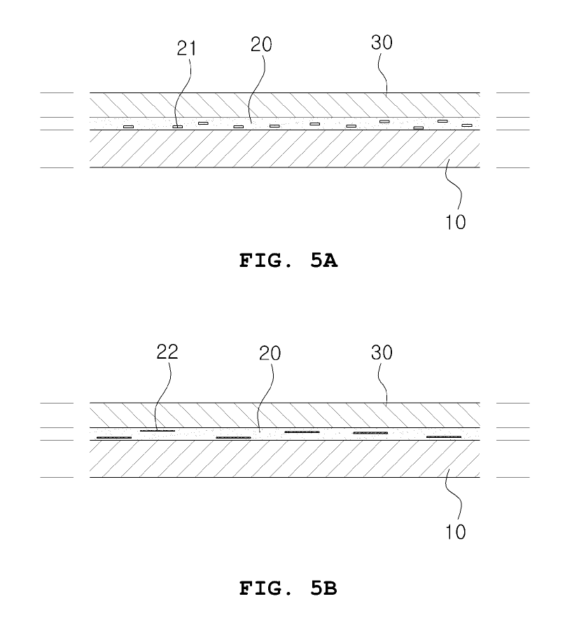

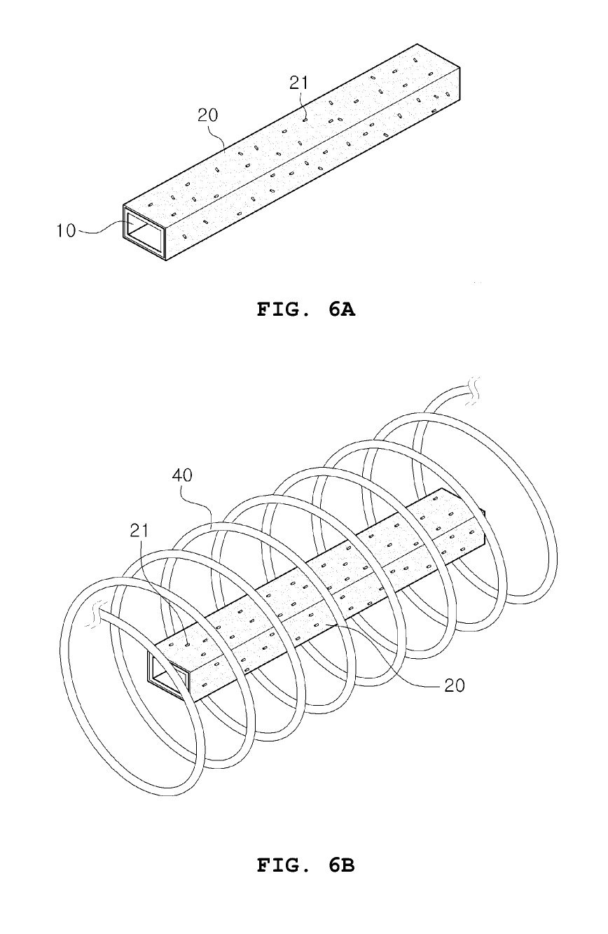

FIG. 1 is a perspective view illustrating a wood frame using a water soluble adhesive in accordance with the present invention, FIGS. 2A and 2B are conceptual views illustrating a bonding order of the wood frame in accordance with the present invention, FIGS. 3A to 3C are cross-sectional views illustrating guide parts formed on a metal frame in accordance with the present invention, FIG. 4 is a cross-sectional view illustrating cutting parts formed in the metal frame in accordance with the present invention, FIGS. 5A and 5B are cross-sectional views illustrating water soluble adhesives containing iron rods and fibers in accordance with the present invention, and FIGS. 6A and 6B are perspective views illustrating the alignment state of the iron rods and the fibers added to the water soluble adhesives in accordance with the present invention.

As exemplarily shown in FIGS. 1 to 2B, the present invention relates to a wood frame using a water soluble adhesive and a manufacturing method thereof and, more particularly to a wood frame using a water soluble adhesive, which is manufactured by coating a metal frame with a wood-plastic composite after application of a water soluble adhesive to the metal frame, and may thus have internal rigidity of metal and have excellent external flexibility, elasticity, water resistance and corrosion resistance, have an eco-friendly texture like natural wood and prevent deformation due to thermal expansion, and a manufacturing method thereof.

A wood frame 100 in accordance with the present invention includes a metal frame 10, a water soluble adhesive 20 and a wood-plastic composite 30 so as to prevent deformation due to a difference in coefficients of thermal expansion using the water soluble adhesive 20.

The metal frame 10 includes reinforcement ribs 15 provided therein so as to increase strength of the metal frame 10.

The reinforcement ribs 15 in the metal frame 10 increase rigidity of the metal frame 10 so that the metal frame 10 may withstand impact and load.

Therefore, the reinforcement ribs 15 may be provided in the metal frame 10 having a shape with an inner space, such as a circular pipe or a rectangular pipe.

The metal frame 10 may be formed of a metal, such as aluminum, iron or stainless steel, so as to have rigidity.

The water soluble adhesive 20 is applied to the metal frame 10.

Here, the water soluble adhesive 20 maintains a semi-solid state having fluidity and may thus absorb changes of materials expanding due to different coefficients of thermal expansion of the metal frame 10 and the wood-plastic composite 30.

Therefore, the water soluble adhesive 20 is formed by mixing 19-20% by weight of modified polyolefin, 59-62% by weight of water, 0.01-5% by weight of isopropyl alcohol and 15-18% by weight of acrylic acid rubber latex.

The wood-plastic composite 30 is formed in a liquid state and is coated on the metal frame 10 to which the water soluble adhesive 20 is applied.

Here, the wood-plastic composite 30 includes 47-60% by weight of wood flour, 30-43% by weight of a plastic compound and 5-10% by weight of additives. The additives include a binder, an antioxidant, a UV stabilizer, a mineral filler, a coloring agent and a heat stabilizer.

The wood-plastic composite 30 is manufactured in a liquid state and may thus be coated on the metal frame 10.

Here, the wood-plastic composite 30 in the liquid state may be coated using physical vapor deposition or chemical vapor deposition and, during coating, the wood-plastic composite 30 may be coated to a designated thickness or more so as to have characteristics and texture of wood.

Further, the wood-plastic composite 30 may be used to express characteristic and texture of wood and the thickness of the wood-plastic composite 30 may be adjusted according to usages.

Therefore, as exemplarily shown in FIG. 2A, the water soluble adhesive 20 is applied to the outer surface of the metal frame 10.

Here, the water soluble adhesive 20 is applied through one of methods, such as spraying, painting, etc., serves to attach the wood-plastic composite 30, which will be subsequently coated, to the metal frame, and may be applied to a thickness which may flexibly cope with a length changed according to thermal contraction and expansion.

Further, as exemplarily shown in FIG. 2B, after application of the water soluble adhesive 20 to the metal frame 10, the wood-plastic composite 30 in a liquid state is coated thereon.

Here, the wood-plastic composite 30 is used to express texture and characteristics of wood and is coated so as to have a designated thickness according to purposes, such as window frames, door frames, handrails, etc.

Therefore, the wood frame 100 having characteristics and texture of wood is manufactured by coating the metal frame 10 with the wood-plastic composite 30.

That is, the wood frame 100 has internal rigidity of metal and has excellent external flexibility, elasticity, water resistance and corrosion resistance, and has an eco-friendly texture like natural wood, thus being capable of being manufactured according to various places and purposes, such as window frames, door frames, handrails, etc.

Further, although the metal frame 10 and the wood-plastic composite 30 may be deformed due to different coefficients of thermal expansion thereof, the water soluble adhesive 20 absorbs strain and may thus prevent the metal frame 10 and the wood-plastic composite 30 from warping or breaking.

Further, as exemplarily shown in FIGS. 3A to 3C, guide parts 11 selectively including protrusions 12 and recesses 13 to prevent deformation due to thermal expansion, caused by the water soluble adhesive 20 applied thereto and the wood-plastic composite 30 coated thereon, are formed on the metal frame 10.

Therefore, a plurality of guide parts 11 including the protrusions 12 or the recesses 13 which are alternately arranged or selectively arranged at constant intervals may be formed.

That is, as exemplarily shown in FIG. 3A, a plurality of protrusions 12 may be formed on the outer surface of the metal frame 10.

Further, as exemplarily shown in FIG. 3B, a plurality of recesses 13 may be formed on the outer surface of the metal frame 10.

Moreover, as exemplarily shown in FIG. 3C, a plurality of protrusions 12 and recesses 13 may be selectively formed on the outer surface of the metal frame 10.

Therefore, the protrusions 12 and the recesses 13 may divide the outer surface of the metal frame 10 to suppress expansion of the metal frame 10 by temperature, and prevent the wood-plastic composite 30 coated on the outer surface of the metal frame 10 from being separated and removed from the metal frame 10, warping, etc.

Further, the protrusions 12 and the recesses 13 may be variously selected so as to be alternately formed or be formed alone, and be arranged at constant intervals or be arranged irregularly according to expansion due to temperature change.

Therefore, the guide parts 11 may suppress expansion and contraction of the metal frame 10, and deform the metal frame 10 so that the metal frame 10 and the wood-plastic composite 30 having different coefficients of thermal expansion correspond to each other in a designated area so as to suppress generation of warpage and breakage, etc.

Further, as exemplarily shown in FIG. 4, cutting parts 14 are formed in the metal frame 10 in the lateral direction so as to prevent deformation of the metal frame 10 due to a coefficient of thermal expansion.

Therefore, a plurality of cutting parts 14 is formed on the outer surface of the metal frame 10 at designated intervals.

That is, the cutting parts 14 formed on the outer surface of the metal frame 10 may prevent deformation of the metal frame 10 throughout the total length thereof during thermal contraction and expansion generated due to temperature change, and minimize deformation of the metal frame 10 throughout the total length thereof even if deformation of a specific area of the metal frame 10 by temperature occurs.

Therefore, the guide parts 11 or the cutting parts 14 of the metal frame 10 may suppress and control thermal expansion of the metal frame 10 and allow expansion and contraction of the metal frame 10 only in a designated area, thus suppressing change of the overall shape of the metal frame 10.

Further, the wood-plastic composite 30 may expand and contract so as to correspond to expansion and contraction of the metal frame 10 to prevent warpage, damage, etc. of the wood-plastic composite 30 due to different coefficients of thermal expansion of the metal frame 10 and the wood-plastic composite 30.

Here, the water soluble adhesive 20 may maintain a semi-solid state having fluidity and absorb strain when the metal frame 10 and the wood-plastic composite 30 expand at different thermal expansion rates.

Further, when the water soluble adhesive 20 receives pressure and load applied from the outside of the wood-plastic composite 30, the water soluble adhesive 20 flows into the cutting parts 14 and may thus reduce impact and load applied from the outside.

As exemplarily shown in FIGS. 5A and 5B and FIGS. 6A and 6B, the water soluble adhesive 20 may include 5-10% by volume of iron rods 21 containing a magnetic substance or fibers 22 containing a magnetic substance, and the wood frame 100 further includes a coil 40, which is disposed such that the metal frame 10, to which the water soluble adhesive 20 containing the iron rods 21 or the fibers 22 is applied, is inserted into the coil 40 and generates current to align the iron rods 21 or the fibers 22.

Here, the iron rods 21 may have magnetic properties by mixing, adding or coating using a magnetic substance, and the fibers 22 may be coated with a magnetic substance so as to have magnetic properties.

Further, iron rods 21 may have a diameter of 0.1 mm to 1 mm.

Therefore, the iron rods 21 having magnetic properties or the fibers 22 coated with the magnetic substance are mixed with or added to the water soluble adhesive 20 so as to be aligned by magnetic force.

The coil 40 is provided at the outside of the metal frame 10 so as to surround the metal frame 10 and aligns the magnetic substance in the water soluble adhesive 20 by current.

Further, the coil 40 is fixed to the outside and, after the coil 40 generates current and thus aligns the iron rods 21 or the fibers 22 in the water soluble adhesive 20 of the metal frame 10, the coil 40 may be removed.

That is, as exemplarily shown in FIG. 6A, the water soluble adhesive 20 containing the iron rods 21 or the fibers 22 including the magnetic substance is applied to the metal frame 10.

Thereafter, as exemplarily shown in FIG. 6B, the metal frame 10 is inserted into the coil 40 formed to surround the metal frame 10 and generating current.

Here, the iron rods 21 or the fibers 22 in the water soluble adhesive 20 are aligned in the length direction by current generated by the coil 40.

Thereafter, the wood-plastic composite 30 is coated on the outer surface of the applied water soluble adhesive 20.

Therefore, the iron rods 21 and the fibers 22 added to the water soluble adhesive 20 and aligned by magnetic force may suppress changes of the metal frame 10 and the wood-plastic composite 30 due to thermal expansion, and the iron rods 21 and the fibers 22 may flexibly absorb changes of the deformed metal frame 10 and a wood-plastic composite 30 and thus prevent the metal frame 10 and the wood-plastic composite 30 from warping and being damaged.

Further, the water soluble adhesive 20 may be uniformly applied to the metal frame 10.

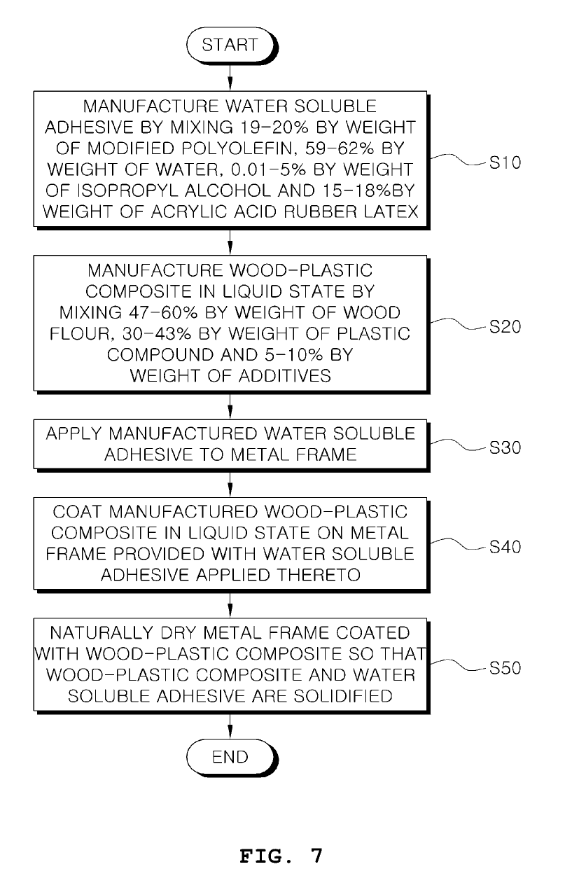

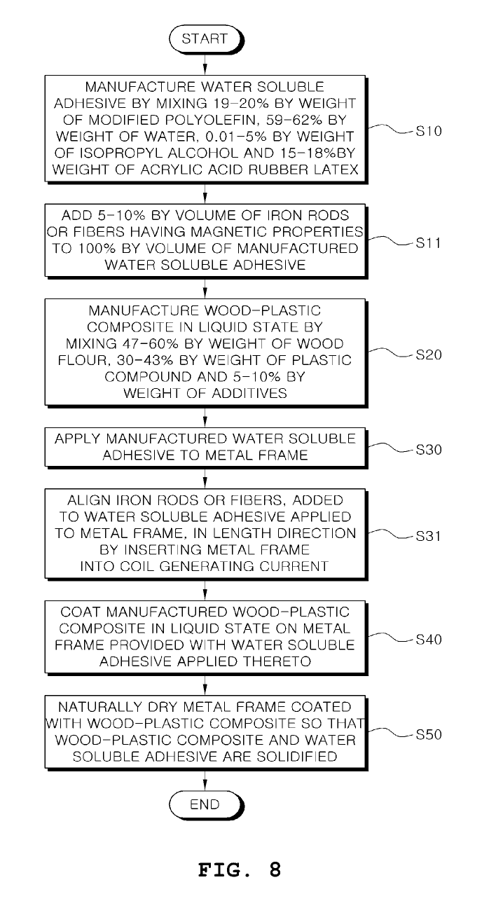

FIG. 7 is a flowchart illustrating a manufacturing method of a wood frame using a water soluble adhesive in accordance with the present invention, and FIG. 8 is a flowchart illustrating a manufacturing method of a wood frame containing iron rods or fibers in accordance with the present invention.

As exemplarily shown in FIG. 7, a manufacturing method of a wood frame using a water soluble adhesive in accordance with the present invention includes first manufacturing (Operation S10), second manufacturing (Operation S20), applying (Operation S30), coating (Operation S40), and drying (Operation S50) so that a metal frame and a wood-plastic composite having different coefficient of thermal expansion may be attached to each other by the water soluble adhesive.

In first manufacturing (Operation S10), the water soluble adhesive is manufactured by mixing 19-20% by weight of modified polyolefin, 59-62% by weight of water, 0.01-5% by weight of isopropyl alcohol and 15-18% by weight of acrylic acid rubber latex.

The water soluble adhesive maintains a semi-solid state having fluidity so as to attach the metal frame and the wood-plastic composite formed of materials having different coefficients of thermal expansion and to absorb changes of the materials by thermal expansion.

Therefore, modified polyolefin is an organic material formed by addition polymerization of olefin, and has increased draw ratio and tensile strength, a low specific gravity and excellent chemical resistance and water resistance.

Isopropyl alcohol has lower polarity than that of methanol or ethanol but has a high boiling point, thus being easily used at normal temperature and pressure.

Acrylic acid rubber latex is a chain-type or net-type material artificially manufactured by repeatedly bonding units having a very small molecular weight, has a great molecular weight, and is used in addition polymerization, condensation polymerization, etc.

That is, the water soluble adhesive is easily used at normal temperature, has increased draw ratio and tensile strength and excellent water resistance, maintains a semi-solid state, and absorbs changes of the metal frame and the wood-plastic composite even if the metal frame and the wood-plastic composite are deformed according to coefficients of thermal expansion thereof so as to easily attach the metal frame and the wood-plastic composite to each other.

Therefore, the water soluble adhesive attaches the metal frame and the wood-plastic composite to each other, and maintains a semi-solid state having fluidity to absorb changes of the metal frame and the wood-plastic composite even if the metal frame and the wood-plastic composite having different coefficients of thermal expansion are deformed at different expansion rates.

In second manufacturing (Operation S20), the wood-plastic composite in a liquid state, in which 47-60% by weight of wood flour, 30-43% by weight of a plastic compound and 5-10% by weight of additives are mixed, is manufactured.

The wood-plastic composite may be formed in a liquid state so as to be coated on the metal frame to which the water soluble adhesive is applied.

Here, the wood flour may be pure wood flour processed from hardwood and be acquired from recycled wood. Since humidity of the wood flour may influence formation of the surface of a raw material and a product and generate voids, the wood flour is used after drying.

Further, if the wood flour is exposed to a high temperature for a long period of time during drying, the wood flour may emit volatile substances, be discolored, cause odors and be degraded. Therefore, the drying temperature of the wood flour may be 200° C. or less.

As the plastic compound, PE, PP, PVC, ABS, etc. may be used, recycled plastic and a virgin material may be mixed, or two or more components of recycled plastic may be mixed.

Finally, the additives include a binder, an antioxidant, a UV stabilizer, a mineral filler, a coloring agent and a heat stabilizer so as to stably maintain the wood-plastic composite.

The binder may improve an interface between two materials, i.e., plastic having hydrophobicity, i.e., non-polarity, and wood flour having hydrophilicity, i.e., polarity, through new chemical bonding, and increase bending strength and modulus of elasticity to maximize dimensional stability and impact strength of a product and to prevent distribution of the wood flour.

The antioxidant and the UV stabilizer block oxygen approach to the wood-plastic composite (WPC) and block ultraviolet light from sunlight to prevent discoloring of the WPC.

The mineral filler may improve lubricity of the WPC, improve processability of the WPC through absorption of moisture from wood fibers, and prevent long-term deformation due to impact strength, bending strength, thermal damage temperature and load.

The coloring agent may provide stability to the color of the WPC, express an external appearance like wood, and improve UV resistance.

The heat stabilizer may minimize distribution of the wood-plastic composite due to heat during processing and use, maintain the original color of the wood-plastic composite, and improve lubricity of plastic.

That is, the additives may allow two materials having different components, i.e., the wood flour and the plastic compound, to be mixed and processed into the wood-plastic composite, and improve resistance of the wood-plastic composite to thermal deformation and UV to prevent discoloring and distribution of the wood-plastic composite.

In applying (Operation S30), the water soluble adhesive manufactured in first manufacturing (Operation S10) is applied to the metal frame.

Here, the water soluble adhesive may be uniformly applied to the metal frame to absorb change of the metal frame due to thermal expansion and be applied to a thickness so as to have fluidity.

In coating (Operation S40), the metal frame 10, to which the water soluble adhesive is applied in applying (Operation S30), is coated with the wood-plastic composite in a liquid state manufactured in second manufacturing (Operation S20).

Here, the wood-plastic composite is coated to a designated thickness or more so as to express characteristics and texture of wood, and the coating thickness of the wood-plastic composite may be changed according to purpose.

In drying (Operation S50), the metal frame 10 coated with the wood-plastic composite in coating (Operation S40) is naturally dried so that the wood-plastic composite and the water soluble adhesive are solidified.

Here, drying may be carried in a cool place so as to prevent expansion of the metal frame and the wood-plastic composite due to temperature change.

A manufacturing method of a wood frame including iron rods or fibers in accordance with the present invention, as exemplarily shown in FIG. 8, is the same as the manufacturing method shown in FIG. 7 except that the manufacturing method shown in FIG. 8 further includes adding 5-10% by volume of iron rods or fibers having magnetic properties to 100% by volume of a water soluble adhesive, manufactured in first manufacturing (Operation S10), (Operation S11), and aligning the iron rods or the fibers, added to the water soluble adhesive applied to a metal frame in adding (Operation S30), in the length direction by inserting the metal frame into a coil generating current (Operation S31).

That is, in adding (Operation S11), 5-10% by volume of iron rods or fibers having magnetic properties are added to 100% by volume of the water soluble adhesive, manufactured in first manufacturing (Operation S10).

Here, the iron rods or the fibers may be configured to absorb strain of the metal frame and the wood-plastic composite deformed by thermal expansion.

Further, the iron rods or the fibers may have magnetic properties through methods, such as adding, coating, etc.

In aligning (Operation S31), the iron rods or the fibers, added to the water soluble adhesive in adding (Operation S11), are aligned in the length direction of the metal frame by inserting the metal frame into the coil generating current.

Therefore, the iron rods or the fibers mixed with the water soluble adhesive are aligned in the length direction of the metal frame and thus prevent warpage, damage, etc. of the metal frame and the wood-plastic composite thermally expanding and contracting according to temperature change.

As apparent from the above description, in a wood frame using a water soluble adhesive and a manufacturing method thereof in accordance with the present invention, wood-plastic composite is attached to a metal frame using the water soluble adhesive and thus the manufactured wood frame has internal rigidity of metal and has excellent external flexibility, elasticity, water resistance and corrosion resistance, and has an eco-friendly texture like natural wood.

Further, warpage, damage, etc. of the metal frame and the wood-plastic composite having different coefficients of thermal expansion, caused by expansion and contraction due to temperature change, etc., may be prevented.

Moreover, magnetic substances are mixed with the water soluble adhesive and then uniformly aligned by magnetic force and the water soluble adhesive is attached to the overall adhesive surface of the metal frame, thus preventing warpage, damage, etc. of the metal frame and the wood-plastic composite due to impact.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wood frame using a water soluble adhesive to prevent deformation due to different coefficients of thermal expansion between materials, the wood frame comprising:
a metal frame including reinforcement ribs provided therein to increase strength;
the water soluble adhesive applied to the metal frame; and
a wood-plastic composite in a liquid state coated on the metal frame provided with the water soluble adhesive applied thereto, wherein:
the water soluble adhesive is manufactured by mixing 19-20% by weight of modified polyolefin, 59-62% by weight of water, 0.01-5% by weight of isopropyl alcohol and 15-18% by weight of acrylic acid rubber latex;
the wood-plastic composite is manufactured by mixing 47-60% by weight of wood flour, 30-43% by weight of a plastic compound and 5-10% by weight of additives; and
guide parts selectively including protrusions and recesses to prevent deformation of the metal frame provided with the water soluble adhesive applied thereto and the wood-plastic composite coated thereon due to thermal expansion are formed on the metal frame.

2. The wood frame according to claim 1, wherein cutting parts are formed on the metal frame in the lateral direction so as to divide deformation of the metal frame due to thermal expansion.

3. The wood frame according to claim 1, wherein:
5-10% by volume of iron rods including a magnetic substance or fibers coated with a magnetic substance are added to 100% by volume of the water soluble adhesive; and
after the water soluble adhesive containing the iron rods of the fibers is applied to the metal frame, the metal frame is inserted into a coil to generate current so that the iron rods or the fibers are aligned in the length direction.

4. A manufacturing method of a wood frame using a water soluble adhesive, comprising:
manufacturing a water soluble adhesive by mixing 19-20% by weight of modified polyolefin, 59-62% by weight of water, 0.01-5% by weight of isopropyl alcohol and 15-18% by weight of acrylic acid rubber latex;
manufacturing a wood-plastic composite in a liquid state by mixing 47-60% by weight of wood flour, 30-43% by weight of a plastic compound and 5-10% by weight of additives;
applying the manufactured water soluble adhesive to a metal frame;
coating the manufactured wood-plastic composite in the liquid state on the metal frame provided with the water soluble adhesive applied thereto; and
naturally drying the metal frame coated with the wood-plastic composite so that the wood-plastic composite and the water soluble adhesive are solidified, and
further comprising:
adding 5-10% by volume of iron rods or fibers having magnetic properties to 100% by volume of the manufactured water soluble adhesive, after manufacturing of the water soluble adhesive; and
aligning the iron rods or the fibers, added to the water soluble adhesive applied to the metal frame, in the length direction by inserting the metal frame into a coil generating current, after application of the manufactured water soluble adhesive to the metal frame.
